(19) United States
(12) Patent Application Publication
(10) Pub. No.: US 2025/0388189 A1
(43) Pub. Date: Dec. 25, 2025

(54) VEHICLE EQUIPPED WITH AN IGNITION KEY WITH A SCREEN

(71) Applicant: FERRARI S.P.A., MODENA (IT)

(72) Inventors: Giorgio CUCCIOLLA, Modena (IT); Flavio GARGIULO, Modena (IT); Maximilian ROMANI, Modena (IT)

(21) Appl. No.: 19/236,157

(22) Filed: Jun. 12, 2025

(30) Foreign Application Priority Data
Jun. 19, 2024 (IT) 102024000014065

(51) Int. Cl. B60R 25/24; B60K 35/50; B60K 35/80

(52) U.S. Cl. CPC B60R 25/24; B60K 35/50; B60K 35/80

(57) ABSTRACT

Vehicle having: a powertrain system; an ignition key; a passenger compartment provided with a trim panel, in which there is a housing configured to accommodate and contain the ignition key; a detection device, which is arranged in close proximity to the housing and is configured to detect the ignition key; and a control unit configured to enable and disable the drive of the vehicle. The housing has: a cavity, which is obtained through the trim panel, develops vertically and is shaped so as to contain the ignition key; a holder, which is mounted inside the cavity in a movable manner so as to translate along a vertical movement direction and has an upper wall shaped so as to receive the ignition key laid on it; and an actuator device configured to move the holder inside the cavity.

### CROSS-REFERENCE TO RELATED APPLICATIONS

This patent application claims priority from Italian patent application no. 102024000014065 filed on Jun. 19, 2024, the entire disclosure of which is incorporated herein by reference.

### TECHNICAL FIELD

The invention relates to a vehicle equipped with an ignition key.

The invention advantageously applies to an electric vehicle, to which explicit reference will be made in the description below without because of this lacking generality.

### PRIOR ART

Since electric vehicles do not have an internal combustion engine, which, in order to be usable, must previously be started and caused to rotate at a minimum speed, they no longer need the so-called “key cycle”, namely the entire electromechanical procedure that leads to the ignition of the combustion engine.

Namely, an electric vehicle is generally equipped with a start button that, when pressed (in the presence of an ignition key), enables the drive, however without acting upon the actual electric motor (which always remains still, until the driver selects the forward or reverse gear and presses the accelerator pedal). However, given the absence of action upon the electric motor and, therefore, in the absence of any type of noise, it is not always immediate for the driver to understand whether the electric vehicle is ready to drive or if some operation is still necessary.

Patent application EP4365005A1 describes a road vehicle provided with an ignition system of an electric powertrain system and comprising: a housing, which is obtained in the central tunnel of the passenger compartment and is configured to receive and house an ignition key, a detection system, which is configured to detect the presence or absence of the ignition key in the housing, and a control unit, which is configured to enable the supply of power to the powertrain system only when the key is detected in the housing. The ignition key comprises a screen (namely, a displaying device), which takes on different colors depending on the state of activation or deactivation of the drive.

Patent application US2018079302A1 discloses a system for controlling the ignition and the selection of the gears of a vehicle by means of one single removable device (namely, an ignition key), which is inserted into a seat obtained in the vehicle console.

Patent application WO2021127753A1 discloses a vehicle ignition control unit comprising an ignition key and a housing configured to partially house the ignition key so that a part of the ignition key protrudes out of the housing.

### DESCRIPTION OF THE INVENTION

The object of the invention is to provide a vehicle equipped with an ignition key, wherein the use of the ignition key to switch the vehicle to drive conditions is simple and intuitive and, at the same time, free from the risk of misinterpretation of the driver's intentions.

According to the invention, there is provided a vehicle equipped with an ignition key as claimed in the appended claims.

The appended claims describe preferred embodiments of the invention and form an integral part of the description.

### BRIEF DESCRIPTION OF THE DRAWINGS

The invention will now be described with reference to the accompanying drawings showing a non-limiting embodiment thereof, wherein:

FIG. 1 is a perspective view of a road vehicle according to the invention;

FIG. 2 is a perspective view, with parts removed for greater clarity, of a dashboard of the road vehicle of FIG. 1;

FIG. 3 is a schematic perspective view of an ignition key of the road vehicle of FIG. 1; and

FIGS. 4, 5 and 6 are schematic views of a housing for the ignition key with the ignition key in different operating positions.

### PREFERRED EMBODIMENTS OF THE INVENTION

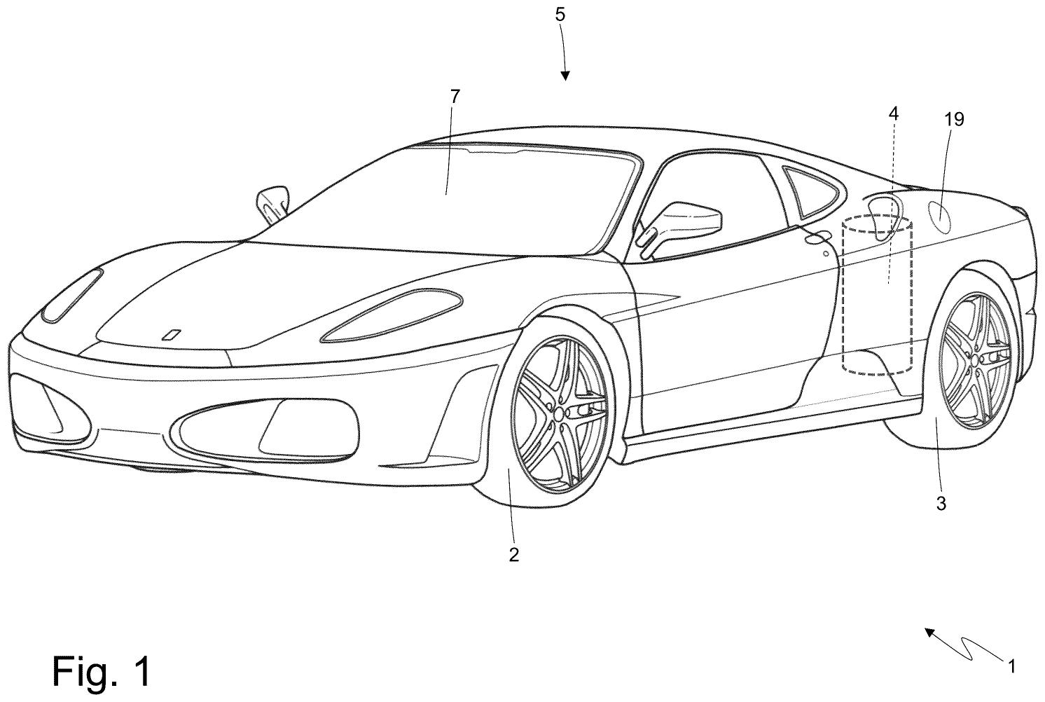

In FIG. 1, reference number 1 indicates, as a whole, an electric road vehicle (in particular, an electric car) having two front wheels 2 (which can be driven or drive wheels) and two rear wheels 3 (which are drive wheels).

The road vehicle 1 comprises a purely electric powertrain system 4, namely provided with only one or several electric motors, which are connected to the rear wheels 3 (and, if necessary, also to the front wheels 2).

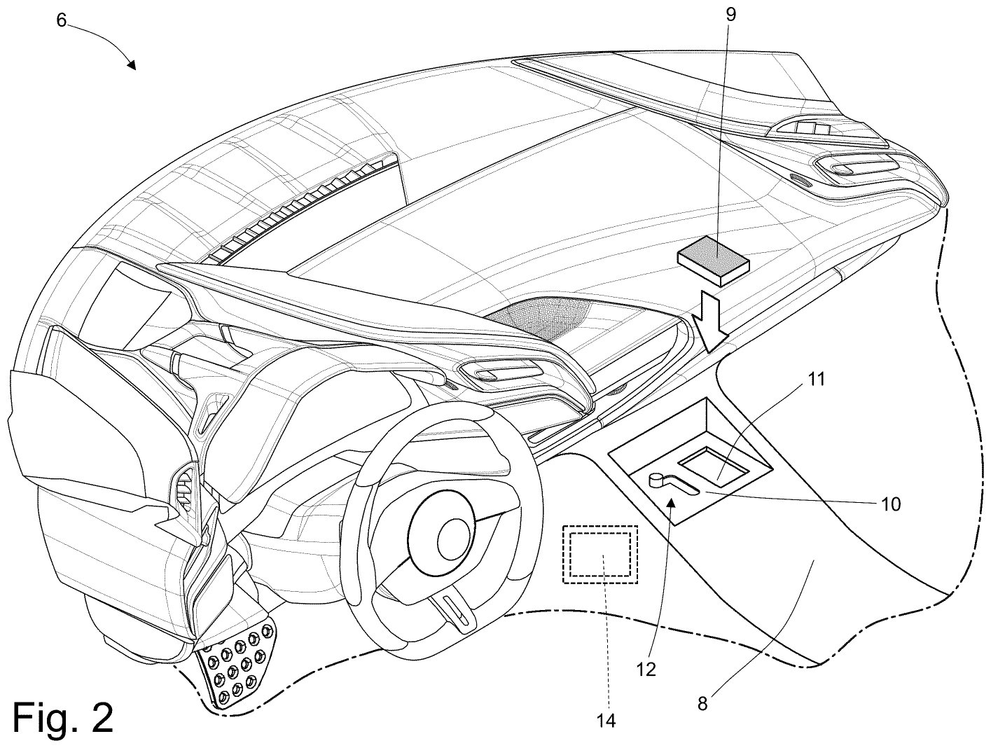

The road vehicle 1 comprises a passenger compartment 5, which is arranged between the two front wheels 2 and the two rear wheels 3, is delimited at the front by a dashboard 6 (shown in FIG. 2) arranged under a windshield 7 and houses (at least) two seats, which are separated from one another by a central tunnel 8 (shown in FIG. 2), which is arranged along a longitudinal symmetry axis of the vehicle 1 (namely, of the passenger compartment 5).

According to FIG. 2, the vehicle 1 comprises (at least) an ignition key 9, which, among other things, is configured to authorize the enabling of the drive of the road vehicle 1 (the so-called “start” of the powertrain system 4), namely to authorize the movement of the road vehicle 1 due to the thrust of the powertrain system 4. The ignition key 9 comprises an electronic device (typically, a transponder) which can be interrogated remotely (namely, without direct contact) and contains encrypted security codes.

The central tunnel 8 is (at least partly) delimited at the top by a trim panel 10, which is substantially horizontal. In the trim panel 10 there is a housing 11 configured to accommodate and contain the ignition key 9 and a gearbox control 12, which is arranged through the trim panel 10 beside the housing 11.

The road vehicle 1 comprises a detection device 13 (schematically shown in FIGS. 4, 5 and 6), which is arranged close to the housing 11 and is configured to detect the ignition key 9 and, in particular, to determine whether the ignition key 9 is actually authorized to enable the drive of the road vehicle 1.

The road vehicle 1 comprises a control unit 14, which, among other things, is configured to recognize the presence of the ignition key 9 through the detection device 13 and, thus, to enable and disable the drive of the vehicle 1 (obviously, only if the ignition key 9 is actually authorized to enable the drive of the road vehicle 1).

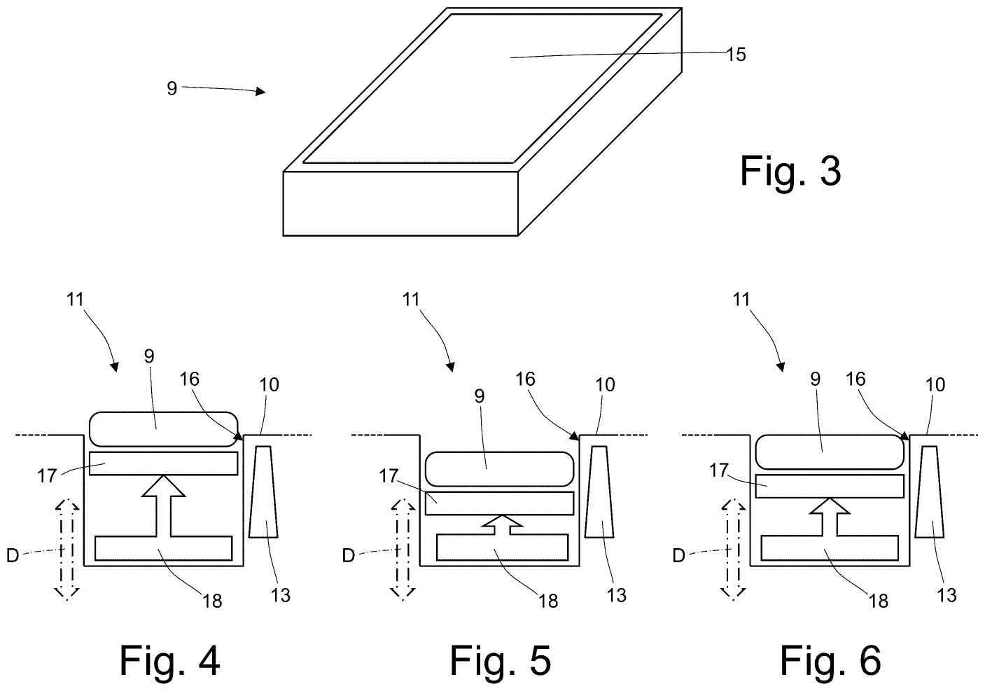

According to FIG. 3, the ignition key 9 has a parallelepiped shape with a rectangular cross section and has a screen 15, which is arranged in the area of an upper wall opposite a lower wall, which is laid in the housing 11. According to a preferred, though non-limiting embodiment, the screen 15 is made with electronic ink (“E-Ink”) technology to minimize electricity consumption (alternatively, the screen 15 is made with LCD, LED or OLED technology). Namely, the ignition key 9 has two wider walls, which respectively are an upper wall, where the screen 15 is located, and a lower wall, which is opposite the upper wall and is laid in the housing 11.

According to FIGS. 4, 5 and 6, the housing 11 comprises a cavity 16 with a parallelepiped shape, which is obtained through the trim panel 10, develops vertically downwards and is shaped to contain the ignition key 9 (namely, it has a parallelepiped shape, which reproduces the shape of the ignition key 9 in negative). In addition, the housing 11 comprises a holder 17 (also called “lift”), which constitutes a bottom wall of the cavity 16, is mounted inside the cavity 16 in a movable manner so as to translate along a vertical movement direction D and has an upper wall shaped to receive the ignition key 9 laid on it; namely, in use, the ignition key 9 is laid on the upper wall of the support 17 (which constitutes the bottom wall of the cavity 16, namely delimits the cavity 16 at the bottom). Finally, the housing 11 comprises an actuator device 18, which can be controlled by the control unit 14 and is configured to move the holder 17 within the cavity 16 and along the vertical movement direction D. In other words, the actuator device 18 is provided with an electric motor, which can be controlled by the control unit 14 to apply an adjustable force and/or displacement to the holder 17.

The holder 17 is movable (under the control of the actuator device 18) between: an upper position (shown in FIG. 4), in which the ignition key 9 resting on the holder 17 protrudes from the cavity 16 and, thus, protrudes from the trim panel 10, an intermediate position (shown in FIG. 6), in which the holder 17 is arranged lower than the upper position (shown in FIG. 4) and the ignition key 9 resting on the holder 17 is flush with an outer surface of the trim panel 10, and a lower position (shown in FIG. 5), in which the holder 17 is arranged lower than the intermediate position (shown in FIG. 6) and the ignition key 9 resting on the holder 17 is completely inside the cavity 16, lower than the outer surface of the trim panel 10.

The actuator device 18 can be controlled by the control unit 14 and is configured to move the holder 17 inside the cavity 16 and in both ways along the vertical movement direction D (namely, alternately upwards and downwards); in other words, the actuator device 18 is configured both to move the holder 17 inside the cavity 16 and downwards and to move the holder 17 inside the cavity 16 and upwards. In particular, the actuator device 18 is electric, namely is provided with a reversible electric motor, which can alternately rotate in both directions; in other words, a shaft of the electric motor is mechanically connected to the holder 17 (for example, by means of a pinion-rack coupling) and, therefore, by rotating the shaft of the electric motor in one direction, the holder 17 moves downwards and, by rotating the shaft of the electric motor in the opposite direction, the holder 17 moves upwards.

Preferably, in the upper position (shown in FIG. 4), the holder 17 is arranged lower than the outer surface of the trim panel 10 so that the cavity 16 laterally contains the ignition key 9 resting on the holder 17.

Preferably, the upper wall of the holder 17 has an illuminating device, which is turned on when a door of the vehicle is unlocked or opened (for example, for a limited amount of time, which can be 20-40 seconds) so as to indicate to the driver where to place the ignition key 9; the illuminating device of the upper wall of the holder 17 could be turned on with a variable brightness, which alternately increases and decreases, creating a “flashing” effect (namely, a so-called “fade-in & fade-out” effect). Obviously, the illuminating device of the upper wall of the holder 17 is immediately turned off once the ignition key 9 is placed on the upper wall of the holder 17 (for example, due to the signal provided by the detection device 13).

The actuator device 18 is configured to hold the holder 17 in a given position with a calibrated holding force (of the order of 5-20 Newtons) and to yield, thus allowing the holder 17 to move downwards, if the holder 17 is pressed, in particular manually by the driver, with a thrust greater than the holding force. Namely, when the holder 17 is in the upper position (shown in FIG. 4) or in the intermediate position (shown in FIG. 6), the driver can manually press the ignition key 9 (which rests on the holder 17) to push the holder 17 downwards, overcoming the calibrated holding force generated by the actuator device 18.

The road vehicle 1 has three states: disabled drive (“POWER OFF” or “KEY OFF”) with off user interface (“HMI OFF”), in which it is not possible to drive the road vehicle 1 (the drive is disabled) and it is not possible to interact with the user interface (for example, the audio system cannot be turned on), disabled drive (“POWER OFF” or “KEY OFF”) with on user interface (“HMI ON”), in which it is not possible to drive the road vehicle 1 (the drive is disabled), but it is possible to interact (if necessary, only partially, namely with limitations) with the user interface (for example, the audio system can be turned on), and enabled drive (“POWER ON” or “KEY ON”), in which it is possible to drive the road vehicle 1 (the drive is enabled) and it is obviously possible to fully interact (namely, without limitations) with the user interface.

The disabled drive state (“POWER OFF” or “KEY OFF”) with off user interface (“HMI OFF”) is reached by locking the door locks or if the road vehicle 1 is left in the disabled drive state (“POWER OFF” or “KEY OFF”) with the user interface on (“HMI ON”) without any user on board. There are wake-up controls in the car that allow you to switch from the disabled drive state (“POWER OFF” or “KEY OFF”) with off user interface (“HMI OFF”) to the disabled drive state (“HMI OFF”) with on user interface (“HMI ON”).

More in general, the disabled drive state (“POWER OFF” or “KEY OFF”) with on user interface (“HMI ON”) is reached by unlocking the door locks of the road vehicle 1 or by using the wake-up controls.

The illuminating device of the holder 17 is activated for a given amount of time whenever the disabled drive state (“POWER OFF” or “KEY OFF”) with off user interface (“HMI OFF”) is switched to the disabled drive state (“POWER OFF” or “KEY OFF”) with on user interface (“HMI ON”); as mentioned above, when the illuminating device of the holder 17 is activated, it slowly pulsates with a “fade-in & fade-out” effect, for example for 20-40 seconds.

In order to switch to the enabled drive state (“POWER ON” or “KEY ON”), the driver places the ignition key 9 in the housing 11, namely on the holder 17 of the housing 17, and, hence, places the ignition key 9 in the upper position (shown in FIG. 4); subsequently, the driver presses the ignition key 9 until it reaches the lower position (shown in FIG. 5) and then releases it. At this point (namely, upon release of the ignition key 9), if the ignition key 9 has been recognized as valid, the control unit 14 controls the actuator device 18 so as to move the holder 17 to the intermediate position (shown in FIG. 6), the drive of the road vehicle 1 is enabled (namely, the state shifts to enabled drive state) and a “start ceremony” is performed, which entails, among other things, turning on the screens of the dashboard 6 and turning on the backlight of the controls. Alternatively, at this point (namely, upon release of the ignition key 9), if the ignition key 9 has not been recognized as valid or if, for some other reason, the start is rejected, the control unit 14 controls the actuator device 18 so as to move the holder 17 to the upper position (shown in FIG. 4) and, obviously, the drive of the road vehicle 1 is not enabled (namely, the drive remains disabled).

The driver can switch from the enabled drive state (“POWER ON” or “KEY ON”) to the disabled drive state (“POWER OFF” or “KEY OFF”) with on user interface (“HMI ON”) by pressing down on the ignition key 9 in order to move the holder 17 from the intermediate position (shown in FIG. 6) to the lower position (shown in FIG. 5) and then release it. At this point (namely, upon release of the ignition key 9), if the gearbox control 12 is in a park position (also called, in short, “P” position), the control unit 14 controls the actuator device 18 so as to move the holder 17 to the upper position (shown in FIG. 4), the drive of the road vehicle 1 is disabled (namely, the state shifts to disabled drive state) and a “closing ceremony” is performed, which entails, among other things, turning off the screens of the dashboard 6 and turning off the backlight of the controls. Alternatively, at this point (namely, upon release of the ignition key 9), if the gearbox control 12 is not in the park position (also called, in short, “P” position) or if, for any other reason, the turning off is rejected, the control unit 14 controls the actuator device 18 so as to move the holder 17 to the intermediate position (shown in FIG. 6) and, obviously, the drive of the road vehicle 1 is not disabled (namely, the drive remains enabled).

The driver can obtain the switch from the enabled drive state (“POWER ON” or “KEY ON”) to the disabled drive state (“POWER OFF” or “KEY OFF”) with on user interface (“HMI ON”) also by opening an electric charging flap 19 (shown in FIG. 1), when the gearbox control 12 is in the parking position (also called, in short, “P” position); also under these conditions, the control unit 14 controls the actuator device 18 to move the holder 17 to the upper position (shown in FIG. 4), the drive of the road vehicle 1 is disabled (namely, the state shifts to disabled drive state) and the “closing ceremony” is performed.

According to a preferred embodiment, the screen 15 of the ignition key 9 is configured to show a first background color (for example yellow, but it could also be another color), if the drive of the road vehicle 1 is disabled, and to show a second background color (for example black, but it could also be another color) different from the first color, if the drive of the road vehicle 1 is enabled. Preferably, the first background color is different from a color of the outer surface of the trim panel 10 so that the ignition key 9 is clearly visible in the middle of the trim panel 10, when the drive of the road vehicle 1 is disabled (and, therefore, the ignition key 9 could be taken up by the driver), whereas the second background color is the same as the color of the outer surface of the trim panel 10 so that the ignition key 9 is “hidden” (“camouflaged”) in the middle of the trim panel 10, when the drive of the road vehicle 1 is enabled (and, therefore, the ignition key 9 must not be taken up by the driver).

In other words, to summarize the above, when the drive of the road vehicle 1 is disabled and once the holder 17 on which the ignition key 9 is resting has been manually pushed by the driver from the upper position (shown in FIG. 4) to the lower position (shown in FIG. 5), the control unit 14 is configured to move the holder 17 to the intermediate position (shown in FIG. 6) and to enable the drive of the road vehicle 1 (namely, to enable the movement of the road vehicle 1 by means of the powertrain system 4), if the ignition key 9 has been recognized as enabling (and, at the same time, the screen 15 of the ignition key 9 changes the background color), or the control unit 14 is configured to move the holder 17 to the upper position (shown in FIG. 5) without enabling the drive of the road vehicle 1, if the ignition key 9 has not been recognized as enabling (and the screen 15 of the ignition key 9 does not change the background color).

Obviously, other “side” conditions may be required to enable the drive of the road vehicle 1 (namely, to enable the movement of the road vehicle 1 by means of the powertrain system 4) and these conditions must occur together with the movement of the holder 17 (on which the ignition key 9 is resting) from the upper position (shown in FIG. 4) to the lower position (shown in FIG. 5); for example, the gearbox control 12 must be in the park position (called, in short, “P” position) and a brake pedal must be pressed.

In addition, when the drive of the road vehicle 1 is enabled and once the holder 17 on which the ignition key 9 is resting has been manually pushed by the driver from the intermediate position (shown in FIG. 6) to the lower position (shown in FIG. 5), the control unit 14 is configured to move the holder 17 to the intermediate position (shown in FIG. 6) without disabling the drive of the road vehicle 1 (and the screen 15 of the ignition key 9 ignition does not change the background color), if there are not all the conditions to disable the drive of the road vehicle 1, or the control unit 14 is configured to move the holder 17 to the upper position (shown in FIG. 5) and to disable the drive of the road vehicle 1 (namely, to disable the movement of the road vehicle 1 by means of the powertrain system 4), if there are all the conditions to disable the drive of the road vehicle 1 (and, at the same time, the screen 15 of the ignition key 9 changes the background color).

Obviously, other “side” conditions may be required to disable the drive of the road vehicle 1 (namely, to disable the movement of the road vehicle 1 by means of the powertrain system 4) and these conditions must occur together with the movement of the holder 17 (on which the ignition key 9 is resting) from the intermediate position (shown in FIG. 6) to the lower position (shown in FIG. 5); for example, the gearbox control 12 must be in the park position (also called, in short, “P” position).

Finally, when the drive of the road vehicle 1 is enabled and once the electric charging flap 19 has been opened, the control unit 14 is configured to move the holder 17 to the upper position (shown in FIG. 5) and to disable the drive of the road vehicle 1 (and, at the same time, the screen 15 of the ignition key 9 changes the background color), if there are all the conditions to disable the drive of the road vehicle 1.

According to a preferred embodiment, the control unit 14 is configured to generate command signals for the ignition key 9, which determine the change of the background color of the screen 15 of the ignition key 9; namely, the ignition key 9 changes the background color of its screen 15 following indications received from the control unit 14.

In the embodiment described above, the powertrain system 4 is exclusively electric, but, according to other embodiments, the powertrain system 4 is only partially electric (namely, it is hybrid) or the powertrain system 4 is exclusively combustion-based.

According to a possible embodiment, the housing 11 comprises a wireless charging system for the ignition key 9, which is arranged in the area of the holder 17 and is configured to charge a battery of the ignition key 9.

The embodiments described herein can be combined with one another, without for this reason going beyond the scope of protection of the invention.

The handling modes disclosed above for the ignition key 9 can advantageously be used in any type of road vehicle (for example, a car or a motorcycle) and also in any type of non-road vehicle.

The road vehicle 1 described above has numerous advantages.

First of all, in the road vehicle 1 described above, the use of the ignition key 9 to switch the road vehicle 1 to drive conditions is particularly simple and intuitive and, at the same time, is free from the risk of misinterpretation of the driver's intentions.

Furthermore, in the road vehicle 1 described above, the use of the ignition key 9 to switch the road vehicle 1 to drive conditions provides the driver with a satisfying and engaging experience (namely, it improves the user's experience).

### LIST OF THE REFERENCE NUMBERS OF THE FIGURES

1 road vehicle
2 front wheels
3 rear wheels
4 powertrain system
5 passenger compartment
6 dashboard
7 windshield
8 central tunnel
9 ignition key
10 trim panel
11 housing
12 gearbox control
13 detection device
14 control unit
15 screen
16 cavity
17 holder
18 actuator device
19 charging flap
D movement direction

1) A vehicle (1) comprising:
a powertrain system (4);
an ignition key (9) configured to authorize the enabling of the drive;
a passenger compartment (5) provided with a trim panel (10) in which there is a housing (11), which is configured to accommodate and contain the ignition key (9) and has a cavity, which is machined through the trim panel (10), develops vertically and is conformed to hold the ignition key (9);
a detection unit (13) that is arranged in close proximity to the housing (11) and is configured to detect the ignition key (9); and
a control unit (14) that is configured to recognize the presence of the ignition key (9) through the detection device (13) and thus to enable and disable the drive of the vehicle (1);
wherein the housing (11) comprises: a holder (17) that constitutes a bottom wall of the cavity (16), is movably mounted within the cavity (16) to translate along a vertical movement direction (D) and has an upper wall conformed to receive in support the ignition key (9); and an actuator device (18) that can be controlled by the control unit (14) and is configured to move the holder (17) within the cavity (16) and along the vertical movement direction (D).

2) The vehicle (1) according to claim 1, wherein the holder (17) is movable between an upper position in which the ignition key (9) resting on the holder (17) protrudes from the cavity (16) and thus protrudes from the trim panel (10), and an intermediate position in which the holder (17) is arranged lower than the upper position and the ignition key (9) resting on the holder (17) is arranged flush with an outer surface of the trim panel (10).

3) The vehicle (1) according to claim 2, wherein in the upper position the holder (17) is arranged lower than the outer surface of the trim panel (10) such that the cavity (16) laterally contains the ignition key (9) resting on the holder (17).

4) The vehicle (1) according to claim 2, wherein an upper wall of the holder (17) has an illuminating device that is turned on when a door of the vehicle is unlocked or opened.

5) The vehicle (1) according to claim 2, wherein the holder (17) is also movable to and from a lower position wherein the holder (17) is arranged lower than the intermediate position and the ignition key (9) resting on the holder (17) is completely inside the cavity (16) lower than the outer surface of the trim panel (10).

6) The vehicle (1) according to claim 5, wherein the actuator device (18) is configured to hold the holder (17) in a given position with a calibrated holding force and to yield allowing the holder (17) to move downwardly if the holder (17) is pressed, particularly manually by the driver, with a thrust greater than the holding force.

7) The vehicle (1) according to claim 6, wherein, when the vehicle drive is disabled and once the holder (17) on which the ignition key (9) is resting is manually pushed by the driver from the upper position to the lower position, the control unit (14) is configured, by controlling the actuator device (18), to:
move the holder (17) to the intermediate position and enable vehicle drive if the ignition key (9) has been recognized as enabling; or
move the holder (17) to the upper position without enabling vehicle drive if the ignition key (9) has not been recognized as enabling.

8) The vehicle (1) according to claim 6, wherein, when vehicle drive is enabled and once the holder (17) on which the ignition key (9) is placed has been manually pushed by the driver from the intermediate position to the lower position, the control unit (14) is configured, by controlling the actuator device (18), to:
move the holder (17) to the intermediate position without disabling vehicle drive if all the conditions for disabling vehicle drive are not met; or
move the holder (17) to the upper position and disable vehicle drive if there are all conditions to disable vehicle drive.

9) The vehicle (1) according to claim 6, wherein, when vehicle drive is enabled and once an electric charging flap (19) has been opened, the control unit (14) is configured to move the holder (17) to the upper position and disable vehicle drive if all conditions to disable vehicle drive are present.

10) The vehicle (1) according to claim 1, wherein:
the ignition key (9) has a screen (15) that is arranged at an upper wall opposite to a lower wall that is resting on the holder (17);
the screen (15) of the ignition key (9) is configured to show a first background color if vehicle drive is disabled and to show a second background color different from the first color if vehicle drive is enabled.

11) The vehicle (1) according to claim 1, wherein the ignition key (9) has a parallelepiped shape with a rectangular cross section.

12) The vehicle (1) according to claim 1 and comprising a central tunnel (8) that is disposed along an axis of longitudinal symmetry of the vehicle (1) and supports the trim panel (10).

13) The vehicle (1) according to claim 1 and comprising a gearbox control (12) that is disposed across the trim panel (10) alongside the housing (11).

14) The vehicle (1) according to claim 1, wherein the actuator device (18) is electric, namely it is provided with an electric motor, and is electrically controllable by the control unit (14).

15) The vehicle (1) according to claim 14, wherein the electric motor can be controlled by the control unit (14) to apply an adjustable force and/or displacement to the holder (17).

16) The vehicle (1) according to claim 14, wherein a shaft of the electric motor is mechanically connected to the holder (17) and, therefore, by rotating the shaft of the electric motor in one direction, the holder (17) moves downwards and, by rotating the shaft of the electric motor in the opposite direction, the holder (17) moves upwards.

17) The vehicle (1) according to claim 1, wherein the actuator device (18) is configured both to move the holder (17) inside the cavity (16) and downwards, and to move the holder (17) inside the cavity (16) and upwards.
